(19) United States
(12) Patent Application Publication
(10) Pub. No.: US 2023/0105145 A1
(43) Pub. Date: Apr. 6, 2023

(54) FLUORESCENT OPTICAL SYSTEM AND FLUORESCENT IMAGE INSPECTION SYSTEM

(71) Applicant: UTECHZONE CO., LTD., New Taipei City (TW)

(72) Inventors: PO-TSUNG LIN, New Taipei City (TW); KUAN-HSUN HUANG, New Taipei City (TW); YUEH-LONG LEE, New Taipei City (TW)

(21) Appl. No.: 17/857,177

(22) Filed: Jul. 5, 2022

(30) Foreign Application Priority Data
Oct. 4, 2021 (TW) 110136919

(51) Int. Cl. G02B 21/06; G02B 21/16; F21V 8/00; G01N 21/64

(52) U.S. Cl. CPC G02B 21/06; G02B 21/16; G02B 6/0008; G01N 21/6458

(57) ABSTRACT

A fluorescent optical system and a fluorescent image inspection system are provided. The fluorescent optical system includes a platform, at least one light source device, and at least one first filter. The platform is configured for placement of a sample to be inspected. The at least one light source device is configured to illuminate the sample to be inspected, so that the sample to be inspected is stimulated to generate a fluorescent light. The at least one first filter is correspondingly arranged in an optical path of the at least one light source device, so that an excitation light passes through the at least one first filter. An incident angle is formed between the excitation light and the platform, and the incident angle is less than 90 degrees.

### CROSS-REFERENCE TO RELATED PATENT APPLICATION

This application claims the benefit of priority to Taiwan Patent Application No. 110136919, filed on Oct. 4, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a fluorescent optical system and a fluorescent image inspection system, and more particularly to a fluorescent optical system and a fluorescent image inspection system having different incident angles.

### BACKGROUND OF THE DISCLOSURE

With industrial progress in the field of full automation, a conventional visual inspection process has been replaced by automatic optical inspection (AOI) for electronic products. AOI has been widely applied in production lines of printed circuit boards for inspection of product appearances.

In industrial fabrication, an automatic optical inspection system is typically used to inspect a surface appearance of an object by capturing an image of the object by a camera device, and then inspecting the same through a computer image processing technology. In this way, it can be quickly determined whether there is a defect (such as an abnormal pattern or a foreign substance) in the product. By virtue of such a non-contact inspection, the automatic optical inspection system can also be used to inspect semi-finished products during a manufacturing process of the production line.

In a scanning illumination technology for fluorescent images, a lamp is implemented as an exciting light source in a structure of the automatic optical inspection system, so as to excite a fluorescent substance on the object to be inspected and obtain the fluorescent image of the object. In a conventional fluorescent microscope system, an objective lens is mainly used for inspection, but a field of view provided thereby is quite limited. Furthermore, a hot spot is easily formed in an image when an inner coaxial illumination is used, and a dichromatic mirror needs to be additionally used during the inner coaxial illumination. Since the thicknesses of a glass and coatings of the dichromatic mirror have to be specifically designed to preclude ghost images and different imaging distances respectively in X and Y directions, designing for lenses having a large size can be even more difficult.

### SUMMARY OF THE DISCLOSURE

In response to the above-referenced technical inadequacies, the present disclosure provides a fluorescent optical system that includes a platform, at least one light source device, and at least one first filter. The platform is configured for placement of a sample to be inspected. The at least one light source device is configured to illuminate the sample to be inspected, such that the sample to be inspected is stimulated to generate a fluorescent light. The at least one first filter is correspondingly arranged in an optical path of the at least one light source device, so that an excitation light passes through the at least one first filter. An incident angle is formed between the excitation light and the platform, and the incident angle is less than 90 degrees.

In another aspect, the present disclosure provides a fluorescent image inspection system that includes a platform, at least one light source device, at least one first filter, an image capturing device, and an inspection device. The platform is configured for placement of a sample to be inspected. The at least one light source device is configured to illuminate the sample to be inspected so that the sample to be inspected is stimulated to generate a fluorescent light. The at least one first filter is correspondingly arranged in an optical path of the at least one light source device, so that an excitation light passes through the at least one first filter. The image capturing device is disposed at one side of the platform so as to capture a fluorescent image of the sample to be inspected. The inspection device is configured to receive the fluorescent image from the image capturing device and inspect a defect of the sample to be inspected according to the fluorescent image. An incident angle is formed between the excitation light and the platform, and the incident angle is less than 90 degrees.

Therefore, compared to a conventional fluorescent optical system, the optical path in the fluorescent optical system provided by the present disclosure is designed to have different incident angles. As such, a fluorescent image inspection is free from limitation of the coaxial light, and control of the irradiation energy within an irradiation range can be more flexible during the fluorescent image inspection. Furthermore, a lens of any size (e.g., a large-size lens) is able to be used in the image capturing device, so as to enlarge a field of view when an image is being captured and reduce formation of hot spots in the image.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a fluorescent image inspection system according to a first embodiment of the present disclosure;

FIG. 2 is a block diagram of an inspection device according to one embodiment of the present disclosure;

FIG. 3 is a schematic view of the fluorescent image inspection system in use according to the first embodiment of the present disclosure;

FIG. 4 is a schematic view of a fluorescent image inspection system according to a second embodiment of the present disclosure; and

FIG. 5 is a schematic view of a fluorescent image inspection system according to a third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

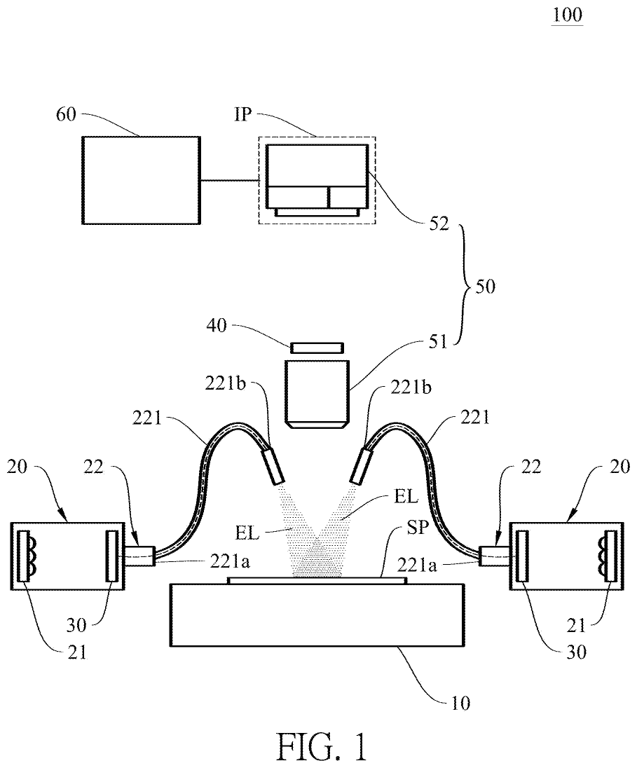

Specific embodiments of the present disclosure are described as follows. Reference is made to FIG. 1, which is a schematic view of a fluorescent image inspection system according to a first embodiment of the present disclosure.

A fluorescent image inspection system 100 is provided in the instant embodiment. The fluorescent image inspection system 100 mainly includes a platform 10, at least one light source device 20, at least one first filter 30, at least one second filter 40, an image capturing device 50, and an inspection device 60.

In one embodiment, the platform 10 is configured to hold a sample to be inspected SP. The platform 10 can be a fixed platform (e.g., a counter or a vacuum adsorption platform) or a movable platform (e.g., a conveyor belt, a linear carrier, or a robotic manipulator, etc.), but the present disclosure is not limited thereto. The sample to be inspected SP can be, for example, a panel, a biological sample, a plant sample, a toxic sample, an oil sample, a stone sample and the like, but the present disclosure is not limited thereto.

In one embodiment, the at least one light source device 20 is disposed near the platform 10, so as to output an excitation light EL to the sample to be inspected SP. The at least one first filter 30 is correspondingly arranged in an optical path of the at least one light source device 20, so that the excitation light EL passes through the at least one first filter 30. In one embodiment, the at least one light source device 20 can be, for example, an LED, a mercury lamp, a laser, and the like. Further, the at least one light source device 20 can provide UV light, blue light, green light, and so on. The types of devices and lights are determined according to various properties (e.g., an excitation intensity or a low damage property) of an organic matter on the sample to be inspected SP in practical implementation, and the present disclosure is not limited to the foregoing examples. In one embodiment, an incident angle that is less than 90 degrees is formed between the excitation light EL and the platform 10. That is to say, an incident direction of the excitation light EL is not parallel to an image capturing direction of the image capturing device 50. In the instant embodiment, the incident angle falls within a range from 49 degrees to 79 degrees. In an exemplary embodiment, the incident angle is 64 degrees, but the present disclosure is not limited thereto.

It is worth mentioning that, in the instant embodiment, a quantity of the light source device 20 included in the fluorescent image inspection system 100 is two, and the two light source devices 20 are disposed at two opposite sides of the platform 10. In other embodiments, the quantity of the light source device 20 can be, for example, one, three, four or more, and these light source devices 20 can be arranged at any location around a periphery of the platform 10. In one embodiment, the fluorescent image inspection system 100 includes multiple ones of the light source device 20, and these light source devices 20 are configured to irradiate the sample to be inspected SP along different incident directions. In another embodiment, the fluorescent image inspection system 100 includes an even number of the light source devices 20 that are equidistant from and symmetric to each other in an annular arrangement. The quantity and position of the at least one light source device 20 are not limited in the present disclosure.

In one embodiment, each light source device 20 includes a light emitting unit 21 and an angle adjusting mechanism 22, and the angle adjusting mechanism 22 is used to adjust an output direction of the excitation light EL. In order to output the excitation light EL at different angles (for purposes of matching a shape of the sample to be inspected SP or enhancing performance of an interested region), the angle adjusting mechanism 22 includes a fiber optic light guide 221 having an input end 221a and an output end 221b. The input end 221a is connected to the at least one first filter 30, and the output end 221b is aligned with the output direction of the excitation light EL, so that the excitation light EL passing through the at least one first filter 30 is guided from the input end 221a to the output end 221b to be output (along a direction from the light emitting unit 21 toward the sample to be inspected SP). By adjusting a shape of the fiber optic light guide 221, an output position and the output direction of the excitation light EL can be adjusted. It should be noted that, relative positions of the at least one first filter 30 and the light source device 20 can be changed according to practical requirements and are not limited in the present disclosure.

In one embodiment, the first filter 30 is used to absorb a visible light, and allows the excitation light EL having a required excitation wavelength to pass through. In one embodiment, the first filter 30 can be, for example, a bandpass filter having a high optical density or a UV filter, but the present disclosure is not limited thereto.

In one embodiment, the at least one second filter 40 is disposed at one side of the platform 10 to correspond to a position of the sample to be inspected SP, so that the excitation light EL can be filtered and a fluorescent light generated from the sample to be inspected SP travels to an image position IP by passing through the second filter 40. The aforementioned “one side” can be a top side, a lower side, a left side, a right side, a front side, or a rear side of an object. The second filter 40 can be arbitrarily disposed at any position near the object, or can be directly or indirectly connected to the object. The present disclosure is not limited to the examples provided herein. More specifically, the image position IP of the instant embodiment represents any position that can receive the fluorescent light reflected by the sample to be inspected SP, and is not limited in present disclosure. An eyepiece, a projected screen, or other similar devices can be set at the image position IP, but the present disclosure is not limited thereto. In one embodiment, the second filter 40 can be, for example, a longpass filter having a high optical density or a UV cut filter, but the present disclosure is not limited thereto.

In one embodiment, the image capturing device 50 includes an image capturing lens 51 and a camera 52. The image capturing lens 51 is disposed between the second filter 40 and the platform 10, and is arranged in a path of the fluorescent light that is transmitted from the sample to be inspected SP to the image position IP. Accordingly, the fluorescent image of the sample to be inspected SP can be magnified by the image capturing lens 51 and then transmitted to the camera 52.

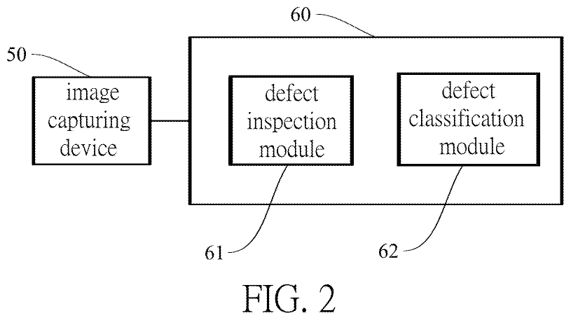

Reference is made to FIG. 2, which is a block diagram of an inspection device according to one embodiment of the present disclosure. The inspection device 60 is coupled to the image capturing device 50, so as to obtain the fluorescent image of the sample to be inspected SP from the image capturing device 50.

In one embodiment, the inspection device 60 can be, such as but not limited to, a computer, a laptop, a server, a working station, or any other electronic device having a computational capability. The inspection device 60 mainly includes a processor, and a memory unit connected to the processor. The processor is used to execute corresponding programs that have been installed in the memory unit. The processor can be, for example, a central processing unit (CPU), any one of programmable microprocessors for a general purpose or a special purpose, a digital signal processor (DSP), a programmable controller, an application specific integrated circuit (ASIC), a programmable logic device (PLD), any other similar device, or any combination thereof.

In the instant embodiment, the processor of the inspection device 60 loads the program stored in the memory unit, so as to execute a defect inspection module 61 and a defect classification module 62. The defect inspection module 61 is used to determine whether or not defects are present according to the fluorescent image, and the defect classification module 62 is used to classify the defects detected by the defect inspection module 61.

Specifically, the defect inspection module 61 can execute a pre-processing procedure (such as image enhancement, noise removal, contrast enhancement, edge enhancement, feature capture, image compression, and image conversion) for normalization of the image. The defect inspection module 61 executes a conventional algorithm (e.g., an image subtraction method), in which a golden image (or a flawless product image) is subtracted from the processed image, so as to obtain the defects of a product. In another embodiment, the defect inspection module 61 can include a machine learning system that has been suitably trained or a deep learning system, so as to determine whether or not any defect is present in the image. However, the present disclosure is not limited thereto.

The defect classification module 62 can include a rule-based algorithm, so as to classify captured images according to a defect shape or a defect feature. In another embodiment, the defect classification module 62 can include a machine learning system that has been trained or a deep learning system to classify the defects. However the present disclosure is not limited thereto.

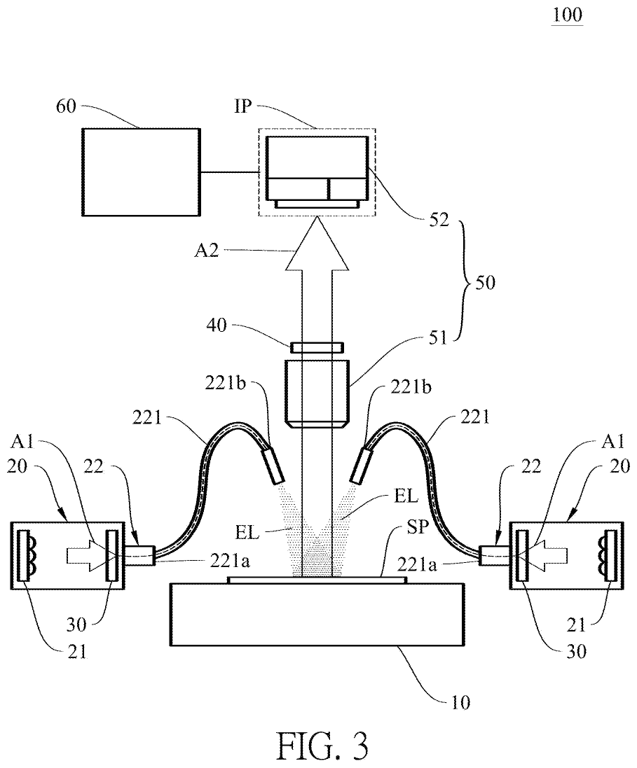

Reference is made to FIG. 3, which is a schematic view of the fluorescent image inspection system during operation according to the first embodiment of the present disclosure.

In the instant embodiment, light outputted from the light emitting unit 21 passes through the first filter 30, which allows the excitation light EL to pass therethrough (as indicated by arrow A1). The output direction of the excitation light EL and a position at which the excitation light EL irradiates the sample to be inspected SP can be controlled by adjusting a position and a shape of the fiber optic light guide 221, such that the excitation light EL can be directed along any axis. In this way, an intensity of the excitation light EL can be improved. When the excitation light EL irradiates the sample to be inspected SP, the fluorescent light is excited and generated from the sample to be inspected SP. The fluorescent light first passes through the image capturing lens 51 (which is indicated by arrow A2) along an open path, then passes through the second filter 40, and to be focused on the image position IP in final. Finally, the image capturing device 50 captures the fluorescent image, and the inspection device 60 performs a defect inspection and a defect classification for the fluorescent image.

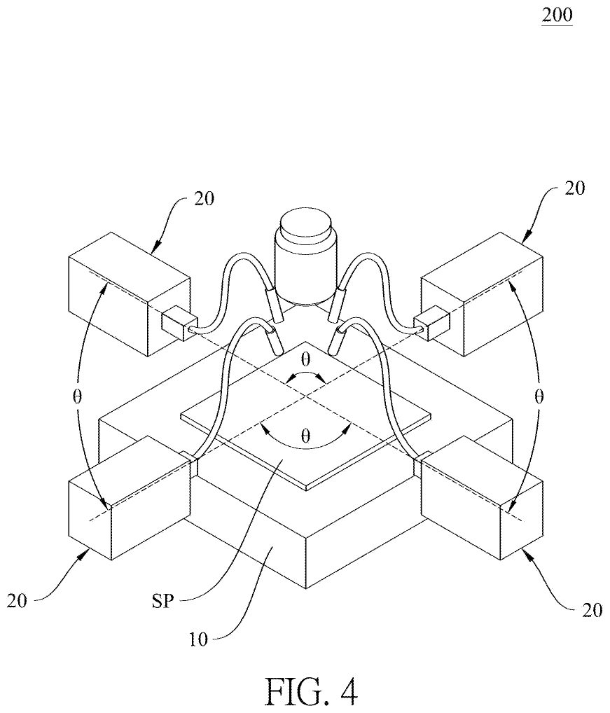

Reference is made to FIG. 4, which is a schematic view of a fluorescent image inspection system according to a second embodiment of the present disclosure. Since the main difference between a fluorescent image inspection system 200 of the instant embodiment and that of the previous embodiment is the quantity of the light source device 20, other elements that are the same as those in the previous embodiment will not be reiterated herein. In the instant embodiment, the quantity of the light source device 20 included in the fluorescent image inspection system 200 is four. The four light source devices 20 are spaced apart from and symmetric to one another in an annular arrangement. An included angle θ of 90 degrees is formed between two adjacent ones of the four light source devices 20. As such, in addition to providing a uniform light source, the energy that can be used for generating the fluorescent light is also increased.

It should be noted that, in the present disclosure, due to the configuration of the light source devices 20, the fluorescent substance of the sample to be inspected SP is stimulated by the excitation light EL that is projected to the sample to be inspected SP from one side thereof. Accordingly, compared to a coaxial light that is conventionally used, control of an irradiation range can be more flexible since the excitation light EL is emitted from a side position relative to the image capturing lens 51. Moreover, by arranging multiple ones of the light source device 20, a larger irradiation range on the sample to be inspected SP can be achieved, and irradiation energy received within the irradiation range can also be precisely controlled. In this way, the sample to be inspected SP can be prevented from being damaged by excessive irradiation energy, and detection efficiency can be significantly improved. For example, when one of the light source devices 20 is arranged at a lower angle relative to the platform 10, the other light source devices 20 can be simultaneously turned on to compensate the irradiation energy of the excitation light EL. When one of the light source devices 20 is arranged at a higher angle relative to the platform 10, all or some of the light source devices 20 can be turned off to decrease the irradiation energy of the excitation light EL. However, the present disclosure is not limited to the abovementioned examples.

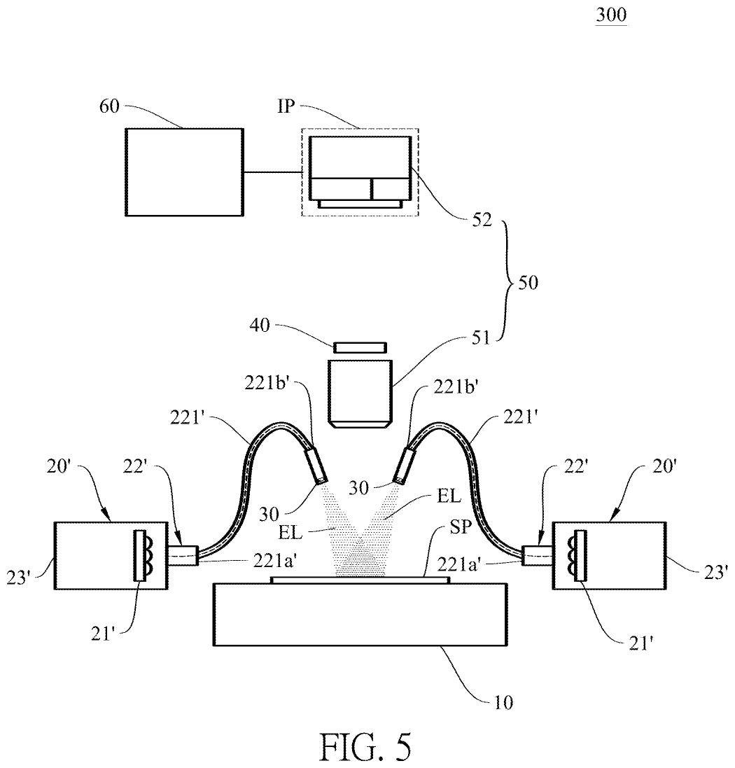

Reference is made to FIG. 5, which is a schematic view of a fluorescent image inspection system according to a third embodiment of the present disclosure. Since the main difference between a fluorescent image inspection system 300 in the instant embodiment and those in the previous embodiments is the structure of the light source device 20, other elements that are the same as those in the previous embodiments will not be reiterated herein.

In the instant embodiment, a light source device 20′ includes a light-emitting unit 21′, an angle adjusting mechanism 22′ and a housing 23′. The light-emitting unit 21′ of this embodiment is disposed in the housing 23′ and is in alignment with an input end 221a′ of a fiber optic light guide 221′. The at least one first filter 30 is arranged at an output end 221b′ of the fiber optic light guide 221′ and located between the light-emitting unit 21′ and the sample to be inspected SP. In this way, light outputted from the light-emitting unit 21′ passes through the first filter 30, and then the excitation light EL is outputted to the sample to be inspected SP.

### Beneficial Effects of the Embodiments

In conclusion, in the present disclosure, the optical path of the excitation light EL is designed to have different incident angles. As such, the fluorescent image inspection is free from limitation of the coaxial light, and control of the irradiation energy within the irradiation range can be more flexible during the fluorescent image inspection. Furthermore, a lens of any size (e.g., a large-size lens) is able to be used in the image capturing device, so as to enlarge a field of view when an image is being captured and reduce formation of hot spots or ghost images in the image.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A fluorescent optical system, comprising:
a platform, configured for placement of a sample to be inspected;
at least one light source device, configured to illuminate the sample to be inspected, such that the sample to be inspected is stimulated to generate a fluorescent light; and
at least one first filter, correspondingly arranged in an optical path of the at least one light source device, so that an excitation light passes through the at least one first filter;
wherein, an incident angle is formed between the excitation light and the platform, the incident angle being less than 90 degrees.

2. The fluorescent optical system according to claim 1, wherein the fluorescent optical system includes multiple ones of the light source device and multiple ones of the first filter, the light source devices illuminate the sample to be inspected along different directions, and the first filters are respectively arranged in the optical paths of the light source devices.

3. The fluorescent optical system according to claim 2, wherein a quantity of the light source devices is an even number, and the light source devices are equidistant from and symmetric to each other in an annular arrangement.

4. The fluorescent optical system according to claim 1, wherein the at least one light source device includes a light emitting unit and an angle adjusting mechanism, and the angle adjusting mechanism is used to adjust an output direction of the light emitting unit.

5. The fluorescent optical system according to claim 4, wherein the angle adjusting mechanism includes a fiber optic light guide having an input end and an output end, and the at least one first filter is disposed between the input end and the light emitting unit.

6. The fluorescent optical system according to claim 4, wherein the angle adjusting mechanism includes a fiber optic light guide having an input end and an output end, and the at least one first filter is disposed at the output end.

7. The fluorescent optical system according to claim 1, wherein the incident angle falls within a range from 49 degrees to 79 degrees.

8. The fluorescent optical system according to claim 1, further comprising a second filter disposed at one side of the platform, wherein the fluorescent light generated from the sample to be inspected travels to an image position by passing through the second filter.

9. The fluorescent optical system according to claim 8, wherein the at least one first filter is a bandpass filter, and the second filter is a longpass filter.

10. The fluorescent optical system according to claim 8, further comprising an image capturing lens disposed between the second filter and the platform, so as to capture a fluorescent image generated from the sample to be inspected.

11. A fluorescent image inspection system, comprising:
a platform, configured for placement of a sample to be inspected;
at least one light source device, configured to illuminate the sample to be inspected, such that the sample to be inspected is stimulated to generate a fluorescent light;
at least one first filter, correspondingly arranged in an optical path of the at least one light source device, so that an excitation light passes through the at least one first filter;
an image capturing device, disposed at one side of the platform, so as to capture a fluorescent image of the sample to be inspected; and
an inspection device, configured to receive the fluorescent image from the image capturing device and inspect a defect of the sample to be inspected according to the fluorescent image;
wherein, an incident angle is formed between the excitation light and the platform, the incident angle being less than 90 degrees.

12. The fluorescent image inspection system according to claim 11, wherein the fluorescent image inspection system includes multiple ones of the light source device and multiple ones of the first filter, the light source devices illuminate the sample to be inspected along different directions, and the first filters are respectively arranged in the optical paths of the light source devices.

13. The fluorescent image inspection system according to claim 12, wherein a quantity of the light source devices is an even number, and the light source devices are equidistant from and symmetric to each other in an annular arrangement.

14. The fluorescent image inspection system according to claim 11, wherein the at least one light source device includes a light emitting unit and an angle adjusting mechanism, and the angle adjusting mechanism is used to adjust an output direction of the light emitting unit.

15. The fluorescent image inspection system according to claim 14, wherein the angle adjusting mechanism includes a fiber optic light guide having an input end and an output end, and the at least one first filter is disposed between the input end and the light emitting unit.

16. The fluorescent image inspection system according to claim 14, wherein the angle adjusting mechanism includes a fiber optic light guide having an input end and an output end, and the at least one first filter is disposed at the output end.

17. The fluorescent image inspection system according to claim 11, wherein the incident angle falls within a range from 49 degrees to 79 degrees.

18. The fluorescent image inspection system according to claim 11, further comprising a second filter disposed at one side of the platform, wherein the fluorescent light generated from the sample to be inspected travels to an image position by passing through the second filter.

19. The fluorescent image inspection system according to claim 18, wherein the at least one first filter is a bandpass filter, and the second filter is a longpass filter.

20. The fluorescent image inspection system according to claim 18, further comprising an image capturing lens disposed between the second filter and the platform so as to capture a fluorescent image generated from the sample to be inspected.
